(19) United States
(12) Patent Application Publication
(10) Pub. No.: US 2011/0286079 A1
(43) Pub. Date: Nov. 24, 2011

(54) PUMPED PIXEL DISPLAY

(75) Inventor: Charles G. Smith, Cambridge (GB)

(73) Assignee: Cambridge Lab on Chip Limited

(21) Appl. No.: 13/061,611

(22) PCT Filed: Sep. 2, 2009
(86) PCT No.: PCT/GB2009/002104

§ 371 Date: Apr. 29, 2011

(30) Foreign Application Priority Data
Sep. 2, 2008 (GB) 0815976.6

(51) Int. Cl. G02F 1/167

(52) U.S. Cl. 359/296

(57) ABSTRACT

A display element, comprising an enclosure containing, in use, a fluid containing a plurality of particles, the enclosure having at least one transparent surface and first and second regions, wherein the second region has a greater area of visibility through the transparent surface than the first region; and driving electrodes for driving the fluid and the particles therein between the first and second regions so that the visibility of the particles through the transparent surface can be varied.

For bright light applications it is an advantage to have a reflective display over a light emitting display, because the light being emitted has to be comparable in brightness to the background illumination for the eye to see it clearly. This means that in bright light conditions extra power is required to increase the display brightness for easy observation. There are a number of technologies used for reflective displays, from liquid crystal to electrophoretic displays in which charged particles which move under the application of an electric field. A third reflective display type uses electro wetting effects while other reflective displays use changes in diffraction from a grating. Liquid crystal displays use polarizers combined with a molecule that is electrically polarizable. The problem with a polarizer displays is that half the light is lost in the polarizerss and so they appear gray in colour. The problem with the charged particle display is that it is hard to add colour. Colour filters can be added, but they do not provide vivid colours. An additional problem with the current displays is that they need to have an address transistor at each pixel. This means greatly increases the cost as an active electronic component needs to be added to each pixel.

This invention seeks to solve these problems by creating a display where each pixel consists of colloidal particles in a solution which is pumped to move the particles from a first region, wherein they cover only a small region of the pixel, or are mostly retained in a concealed region of the pixel, into a second region wherein they are visible to the viewer. By using pigmented particles which are stable to ultra violet (UV) light, bright reflective colour pixels can be created.

According to the present invention there is provided a display element, comprising an enclosure containing, in use, a fluid containing a plurality of particles, the enclosure having at least one transparent surface and first and second regions, wherein the second region has a greater area of visibility through the transparent surface than the first region; and driving electrodes for driving the fluid and the particles therein between the first and second regions so that the visibility of the particles through the transparent surface can be varied.

In an example of the present invention, the enclosure has a screen which divides the enclosure into two regions that the particles can be driven between; a region visible from the transparent surface and a region that is not visible from the transparent surface.

In another example of the present invention, the particles can be driven from a first region provided at an end of the pixel, where they are bunched up such that they cover only a small area of the pixel, to a second region whereby the particles cover most of the pixel area.

The display element may be arranged to be positioned within an array of such elements so as to form a display device. The particles may be black, white or one of a selected predetermined number of colours. The screen may be black, white or one of a selected number of colours so that, in use, a colour display can be formed from either a single element.

In a display formed from an array of elements appropriate drive electrodes may be layered adjacent thereto to individually address each element in a selected row and/or column.

Existing particle based displays use electric fields to move particles in a fluid. By using negatively charged white particles and positively charged black particles, a change in the direction of the electric field applied to the pixel causes the white particles to move to the front of the pixel and the black to move to the back for example. Changing the polarity of the field will cause the opposite to occur. Our proposed display is similar to this in that we are moving particles at each pixel location, but the difference is that we are using the pumping of the fluid containing the particles to cause the change in the reflective properties, rather than DC electric fields moving the particles themselves. There are a number of ways that fluids can be pumped using electric fields. In this application we will describe how electro-osmotic flow is used for pumping, but there are a number of other pumping techniques which are also available. We will describe how using a specific electrode configuration, AC electro-osmotic flow can be generated in one pixel of an array without requiring an active component at that pixel. With just active components at the end of each row and column, fluid flow can be generated at just one pixel where that row and column cross.

An example of the present invention will now be described with reference to the accompanying drawings, in which:

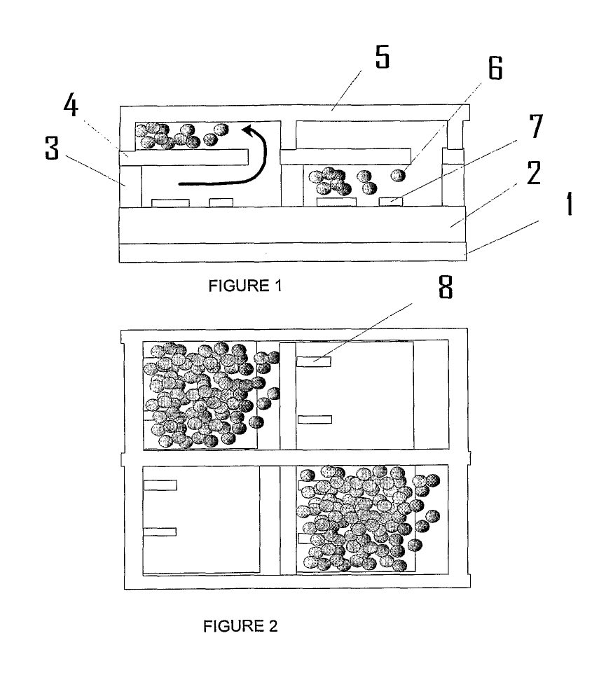

FIG. 1 is a side cross-sectional view of two display elements adjacent to one another, according to a first example of the present invention;

FIG. 2 is a plan view showing four elements positioned adjacent to one another, according to the example of FIG. 1;

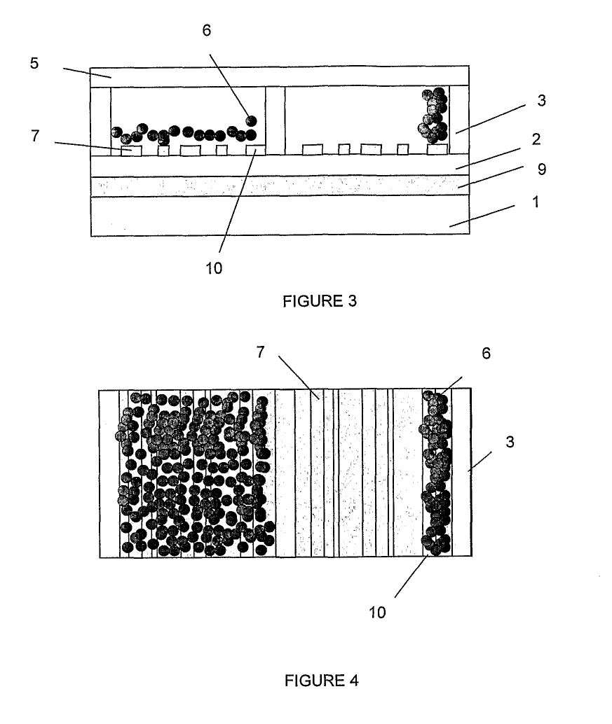

FIG. 3 is a side cross-sectional view of two display elements according to a further example of the present invention;

FIG. 4 is a plan view showing four elements positioned adjacent to one another, according to the example of FIG. 3;

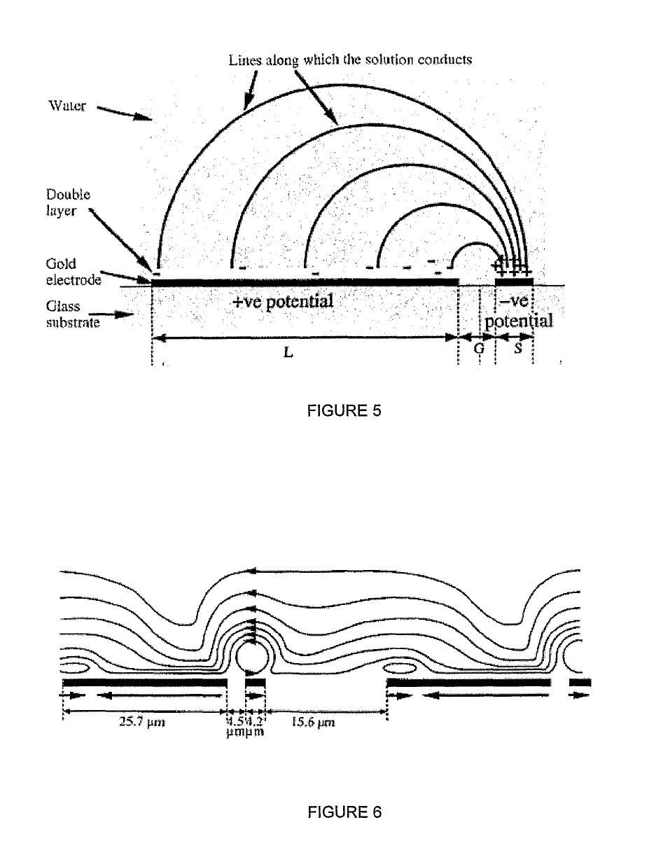

FIG. 5 is a side view of an electric field generated by electrodes employed in the examples shown in FIGS. 1 and 3;

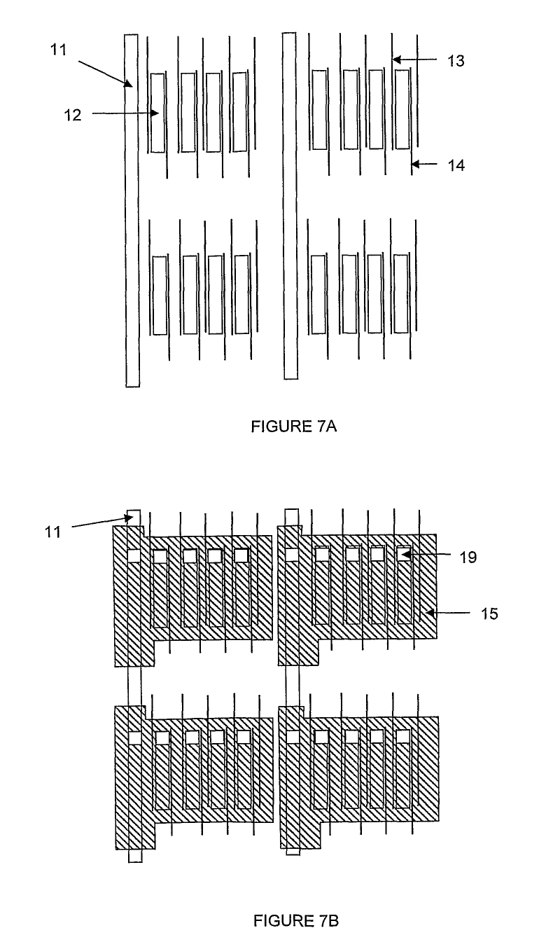

FIG. 6 is a diagram showing a lateral cross section through two electrode pairs showing the resulting lines of constant velocity fluid flow generated by the application of an AC voltage to between the large and small electrodes;

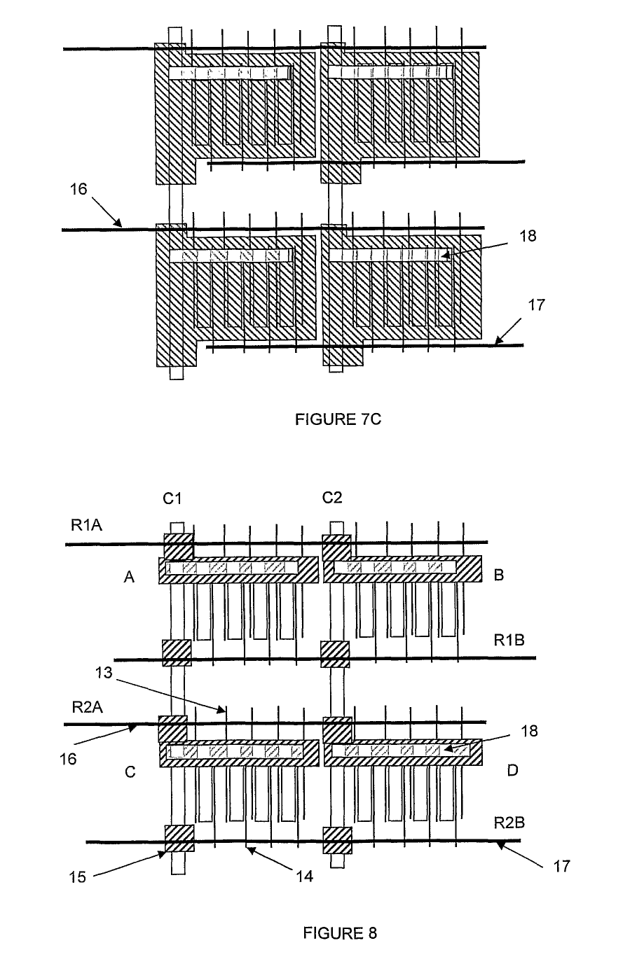

FIGS. 7A to 7C show an example of a construction of electrodes that may be employed in the present invention;

FIG. 8 shows an alternative electrode structure that may be employed in the present invention;

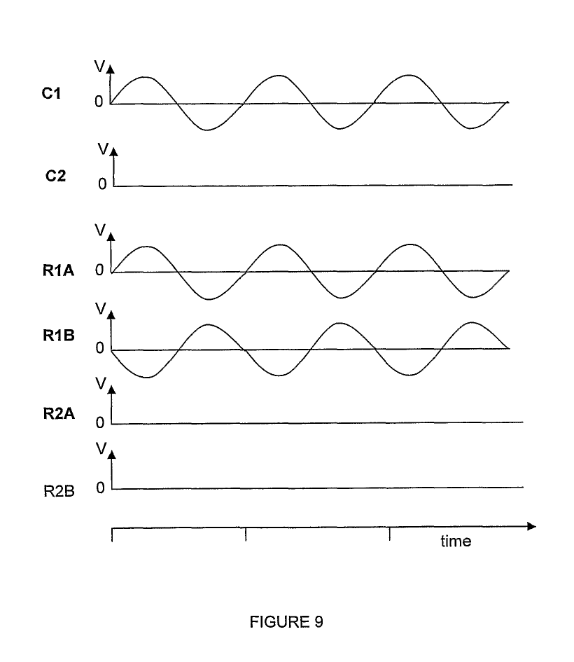

FIG. 9 shows drive voltages that may be employed to drive the electrodes shown in the earlier Figures;

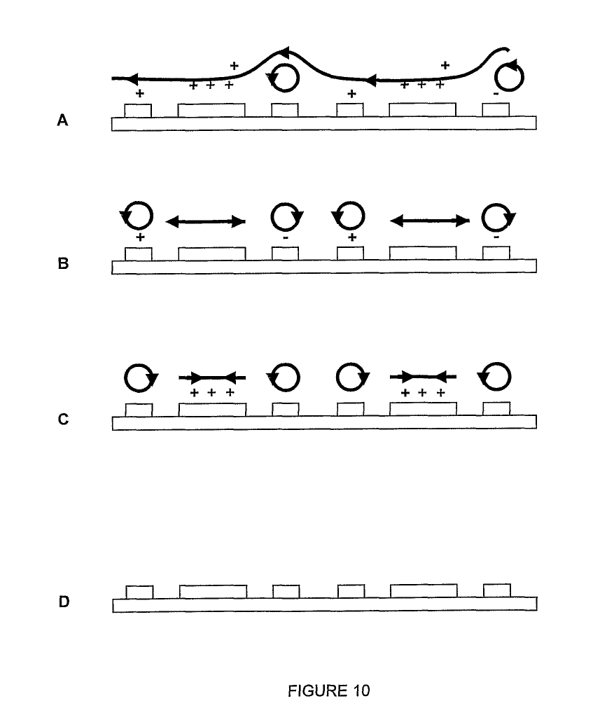

FIG. 10 is a diagram showing a side view through full elements shown in FIG. 8 with the voltage pattern applied from FIG. 9; and

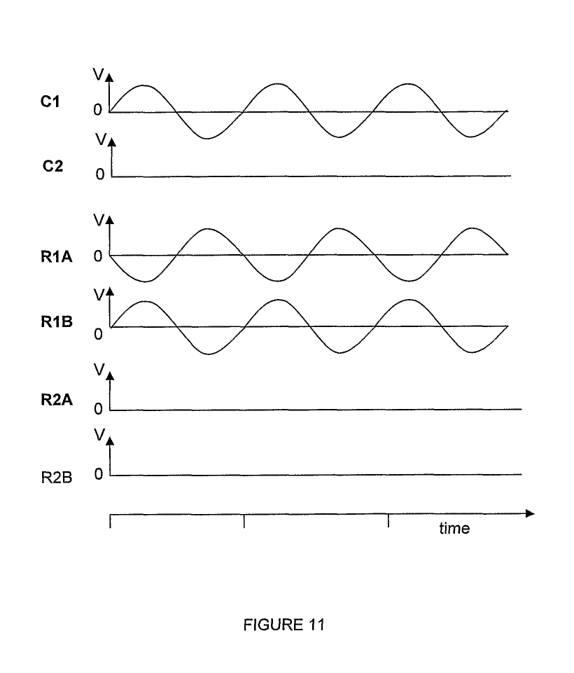

FIG. 11 shows an alternative set of drive voltages that may be employed with the present invention.

FIG. 1 shows a schematic diagram of a side view of two pixels beside each other according to a first example of the present invention. Layer 1 is a substrate material that may be glass or plastic. Layer 2 is an insulating layer that may be glass or plastic for example. Layer 7 consists of patterned conducting electrodes which have connections along both the rows and columns to the edge of the array. This may be made from metal, conducting plastic or conducting transparent material such as ZnO or Indium tin oxide. Layer 3 can be an insulator material, such as SiO2, Si3N4 or SU8-50 photo resist for example or plastic. It should be coated with a white or black coating to give a base pixel colour that is covered by the particles when switched on. It can, for example, be made white with a layer of titanium dioxide or black with a layer of carbon. It is patterned using optical lithography techniques or it could be moulded with layer 4 and placed on top of layer 2. Layer 5 is a transparent layer of plastic or glass that has been etched to contain pits on the underside. The pixels would be of order 200 microns long and may be between 100 and 200 microns wide.

FIG. 2 shows the top view of four pixels showing holes etched through layer 4 to allow fluid to circulate round from the bottom layer up and over on the top of the pixel. Once the fluid flows over the top of layer 4 it can flow back down though the holes in layer 4. The fluid flow drags the colloidal pigmented particles 6. The holes 8 are smaller in width or length than the colloidal particle size. Typically the colloids may be 10 microns in diameter and the holes may be 8 microns or less in width or length.

FIG. 3 show the side view of another example of the present invention showing two pixels, where the substrate 1 is coated with a reflective layer 9 which may be metallic, or a colour that is required when the pigment particles are not covering the pixel. While the electrodes 7 are used for pumping, or driving, fluid containing pigment particles, as will be explained further on, electrode 10 is used for holding the charged pigment particles 6 at a side of the pixel using a DC voltage of opposite polarity to the charged pigment particles 6. Spacers 3 are used to hold up the transparent widow 5.

FIG. 4 shows a top view of two pixels showing the particles spread out over the pixel on the left-hand view and bunched up over electrode 10 on the right-hand view, according to this further example.

The fluid in the cavities of the pixels will be an ionic fluid that forms an ionic double layer over the electrodes. This could be water with some ions dissolved in them. If the electrodes are not equal width then an alternating voltage applied to pairs of electrodes can lead to a fluid flow in one direction. This is known to those skilled in the art. The flow is driven by having two different sized electrodes 7 next to each other; one could be 5 microns wide, while the other is 25 microns wide. When a voltage difference is first applied between the two electrodes 7, the ions build up to a higher concentration along the edge of the large electrode closest to the small electrode, after a small period of time (approximately 1 ms) the ions flow along the width of the large electrode to equalize the concentration gradient. The ions drag fluid with them as they do so. Changing the polarity of the applied voltage leads to the same effect, but with different polarity ions. These ions initially also build up to a higher concentration on the large electrode closest to the small electrode. This process is repeated every time the voltage changes polarity. The velocity of the driven fluid flow then increases with the frequency of the applied AC voltage up to the point where the ions do not have time to flow to the electrode to charge it up. This is the RC time constant for the electrode in that ionic concentration. This is typically between 1000 Hz and 10000 Hz. The voltages required to generate this type of flow are from between 1V and 3V. At higher voltages the fluid flow can be reversed as ions start to be injected from the electrode into solution. This injection occurs preferentially in the high field region close to the small electrode. The injection of ions counteracts the ions flowing to charge up the electrode, and a reverse flow is observed. This fluid flow has been well researched and flows with velocities of 500 microns/second observed.

FIG. 5 shows a side view of one large and one small electrode during one period of the AC applied voltage. The higher density of ions on the large electrode close to the small electrode lead to fluid flow to the left over the large electrode.

FIG. 6 shows a side view cut though four electrodes, two large electrodes (that are electrically connected) and two small electrodes that are electrically connected. The fluid flow lines are shown. This flow reverses when ions start to be injected at the high field side of the large electrode which compensates the ions that are drawn to the electrode from the solution. This reversal of flow occurs at higher voltages above about 4V.

Thus the pixel can be made to change from, for example white to red by pumping fluid containing colloidal pigmented particles from the bottom reservoir to the top. By reversing the flow direction the fluid will move the colloidal pigmented particles back to the bottom cavity resulting in the pixel turning white again.

By careful design of the electrodes it is possible to move colloidal pigmented particles from one region of the pixel to the other, for example from the bottom reservoir to the top or from the top to the bottom, as shown in FIG. 1, by activating electrodes at the periphery of the array of pixels. This is illustrated in FIGS. 7A-7C, which show how the electrodes 7 shown in the previous figures may be constructed. Four pixels are shown to illustrate how an array may work.

FIG. 7A shows the first layer of conducting material, which may be metal or some other conductor and which forms the first layer of the drive electrodes, comprising a column address electrode 11 and a wide electrode 12 used for pumping. The smaller electrodes 13 or 14 will be connected to two separate row electrodes 16 and 17.

In FIG. 7B insulating layer 15 is defined over the electrodes and holes 19 are etched through the insulating layer 15 to allow contact from the wide electrodes 12 to the column address electrode 11 using a connecting electrode 18, as described below and shown in FIG. 7C.

FIG. 7C shows an example of a final two by two pumping array which has two rows of electrodes 16 and 17 and a connecting electrode 18, which connects column electrodes 11 with wide electrodes 12. Row electrode 16 connects to small electrode 13 on the left of large electrode 12 and row electrode 17 connects to small electrode 14 on the right of large electrode 12.

Depending on which row electrode 16 or 17 is selected together with the column address electrode 11 controls the direction of fluid flow.

It is worth noting that the pumping process described above also works when the electrodes are coated with an insulator though the reverse flow is not possible at higher AC voltages. The above design of oxide could be modified slightly to expose the electrodes as shown below.

FIG. 8 shows an array having the same structure as in FIG. 7, but with a smaller areas of insulator 15 that are used to allow separate contact to the wide electrodes 12 without shorting the small electrodes 13 and 14. This allows the electrodes to be exposed to the fluid allowing forward and reverse pumping.

To address one pixel without addressing the other pixels so that we get flow in one direction over the electrodes in that pixel and no net flow over the other pixels we need to activate the column electrode 11 and the two row electrodes 16 and 17 which are connected to the smaller electrodes 13 and 14 respectively. If we want to activate the pixel marked A in FIG. 8 without activating the pixels B, C and D then we need to apply the following AC signals to electrodes C1, C2, R1A, R1B, R2A and R2B.

With reference to FIG. 8, FIG. 9 shows an example of the voltage change with time applied to the various electrodes in a sample two by two array so that pixel A has flow to the left, while no net flow in pixel B, C and D is generated. The period of oscillation may be around 1 to 0.1 ms.

FIG. 10 shows what the fluid flow lines look like in pixel A, B, C and D of the above example, as well as indicating the ionic concentration at one point in the cycle of the AC applied voltages to the various electrodes as shown in FIG. 9. The figure shows a side view of the electrodes with the resulting fluid velocity distribution shown above each electrode.

Pixel A has an asymmetric electric field created above the electrode. This will cause pumping of fluid in a left direction which would result in the movement of the pigment particles around in the pixel cavity. From the right-hand pixel of the cross-section in FIG. 1, we can see that this would move the pigment particles to be hidden in the bottom half of the pixel or, if using the arrangement shown in FIG. 3, this would move the pigment particles from being spread out over the electrodes 7 to being bunched up over electrode 10 where a DC voltage can be applied to keep them in place. All the other pixels have a symmetric electric field developed over the electrodes as a function of time. This may generate some local movement over the electrodes and some small rotating flows may be generated over each electrode, but no net flow will be generated over the electrodes and so the pixel state will not be changed.

FIG. 10 is a diagram showing a side view cut through four pixels shown in FIG. 8 with the voltage pattern applied as shown in FIG. 9.

Thus we can address one given pixel causing a net fluid flow by applying suitable AC signals to two rows and one column while causing no net fluid flow in any if the other pixels.

With reference again to FIG. 8, FIG. 11 shows the voltage change with time applied to the various electrodes in a sample two by two array so that pixel A has flow to the right, while no net flow in pixel B, C and D is generated. It can be seen that the time varying signals applied to the rows and columns generate a flow in pixel A that is in the opposite direction to that shown in FIGS. 9 and 10.

In order for the pixels to switch well, it is important that the colloidal pigmented particles do not stick to the inside of the cavity. This can be ensured by coating the particles and the surfaces of the inside of the pixel cavities so that they are charged in solution and thus the particles are repelled. Steric stabilization can also be used where the surfaces of the particles and the cavity are coated with long chain molecules that sit perpendicularly to the surface.

An alternative technique is to coat layers 5 and 4 with a conducting material which may be a transparent electrode material like ZnO or indium tin oxide. A high frequency of around 5 MHz AC voltage of a few volts will cause negative dielectrophoresis which causes repulsion of particles of a few microns in diameter from the electrodes. A DC voltage of the opposite polarity to the charge induced on the particle surfaces can then be used to hold the particles in place when the pixels are not being switched using the fluid flow.

1. A display element, comprising:
an enclosure containing, in use, a fluid containing a plurality of particles, the enclosure having at least one transparent surface and first and second regions,
wherein the second region has a greater area of visibility through the transparent surface than the first region; and
driving electrodes for driving the fluid and the particles therein between the first and second regions so that the visibility of the particles through the transparent surface can be varied.

2. The display element according to claim 1, the enclosure further comprising a screen for separating the two regions such that the first region is not visible from the transparent surface and the second region is visible from the transparent surface.

3. The display element according to claim 2, wherein the screen has one or more holes provided in it, the one or more holes being arranged to allow the fluid to flow through, while preventing the particles from passing through.

4. The display element according to claim 1, wherein the first region is provided at a side of the enclosure and the second region is substantially the remainder of the enclosure such that when in the first region the particles are bunched up such that they cover only a small area of the enclosure, and in the second region the particles cover most of the enclosure area.

5. The display element according to claim 4, further comprising a holding means for selectively retaining the particles when in the first region.

6. The display element according to claim 1, wherein the driving electrodes comprise a wide electrode and a thin electrode.

7. The display element according to claim 1, wherein the display element is arranged to be positioned within an array of display elements so as to form a display device.

8. The display element according to claim 1, wherein the particles are black, white or one of a selected predetermined number of colors.

9. The display element according to claim 1, wherein the particles are prepared so as to be resistant to ultraviolet bleaching.

10. The display element according to claim 2, wherein the screen is black, white or one of a selected number of colors so that, in use, a color display can be formed from a single display element.

11. The display element according to claim 1, wherein the particles and the surfaces of the inside of the enclosure are coated so that they are charged in solution.

12. A display comprising an array of display elements, each display element comprising:
an enclosure containing, in use, a fluid containing a plurality of particles, the enclosure having at least one transparent surface and first and second regions.
wherein the second region has a greater area of visibility through the transparent surface than the first region; and
driving electrodes for driving the fluid and the particles therein between the first and second regions so that the visibility of the particles through the transparent surface can be varied.

13. A display according to claim 12, wherein driving electrodes are layered adjacent to respective display elements to individually address each display element in a selected row and/or column.

14. A method of selecting an display element from an array of display elements in a display according to claim 12, comprising the steps of:
providing a column address electrode;
providing a plurality of row address electrodes;
providing driving electrodes comprising at least one wide electrode and a smaller electrode positioned either side of the wide electrode, the smaller electrode on a first side of the wide electrode being electrically connected to a first row address electrode and the smaller electrode on a second side of the wide electrode being electrically connected to a second row address electrode; and
selectively activating the column address electrode together with a row address electrode depending on which direction the fluid is required to be driven.

15. The display element according to claim 5, wherein the driving electrodes comprise a wide electrode and a thin electrode.

16. The display element according to claim 15, wherein the display element is arranged to be positioned within an array of display elements so as to form a display device.

17. The display element according to claim 15, wherein the particles are black, white or one of a selected predetermined number of colors.

18. The display element according to claim 17, wherein the particles are prepared so as to be resistant to ultraviolet bleaching.

19. The display element according to claim 15, the enclosure further comprising a screen for separating the two regions such that the first region is not visible from the transparent surface and the second region is visible from the transparent surface, wherein the screen is black, white or one of a selected number of colors so that, in use, a color display can be formed from a single display element.

20. The display element according to claim 19, wherein the particles and the surfaces of the inside of the enclosure are coated so that they are charged in solution.
